(19) United States
(12) Patent Application Publication
(10) Pub. No.: US 2009/0040312 A1
(43) Pub. Date: Feb. 12, 2009

(54) CALIBRATION APPARATUS AND METHOD THEREOF

(75) Inventor: Hiroshi Hattori, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/051,452

(22) Filed: Mar. 19, 2008

(30) Foreign Application Priority Data
Aug. 10, 2007 (JP) 2007-209537

(51) Int. Cl. H04N 17/00

(52) U.S. Cl. 348/187; 348/E17.002

(57) ABSTRACT

A device includes a monitor arranged in a field of view of a camera whose three-dimensional position in the three-dimensional reference coordination system is fixed, and a calculating unit provided in the monitor and configured to display a camera image shot by a camera on a screen of the monitor in a recursive structure by shooting a basic square whose three-dimensional position in the three-dimensional reference coordination system is fixed and a monitor screen including the basic square by the camera and obtain a posture matrix of the camera on the basis of the three-dimensional position of the basic square, the two-dimensional image positions of the basic square in the camera image displayed on the monitor in the recursive structure and the focal distance of the camera.

### CROSS-REFERENCE TO RELATED APPLICATIONS

This application is based upon and claims the benefit of priority from the prior Japanese Patent Application NO. 2007-209537, filed on Aug. 10, 2007; the entire contents of which are incorporated herein by reference.

### TECHNICAL FIELD

The present invention relates to a calibration apparatus for a camera and a method thereof.

### BACKGROUND OF THE INVENTION

Image measuring techniques for measuring the position of or the distance to a target object using images are applicable to robots or autonomy traveling of automotive vehicles and aggressive studies and improvements are in progress here and abroad. For example, if the position or the like of obstacles therearound are measured accurately using images, it is quite effective for realizing safety movement of robots.

In order to achieve image measurement with high degree of accuracy, it is necessary to measure the position or posture of a camera with respect to a coordinate system as a basic standard in advance. This operation is referred to as “camera calibration”. The camera calibration is inevitable for stereo view using a geometric relation among a plurality of cameras as a constraint.

In the related art, the camera calibration is carried out by procedures of shooting a plurality of sample points, whose three-dimensional positions are known, using substances having a known shape, obtaining a projecting position of the respective sample points on an image, and calculating internal parameters such as the position, orientation and, if necessary, focal distance of the camera from the obtained data.

In order to achieve the calibration with high degree of accuracy, a plurality of sample points which are spatially dispersed are required. Therefore, there is a problem that securement of a wide space which is able to include such sample points is needed.

In order to solve this problem, in JP-A 2004-191354 (KOKAI), realization of the calibration with high degree of accuracy in a narrow space is intended. JP-A 2004-191354 discloses a method of using a number of patterns generated by placing two mirrors face to face so as to reflect with each other, so-called “holding mirrors against each other”. This method of generating a dummy wide space with the two mirrors only requires a space for placing these two mirrors, and hence the calibration is possible in a space narrower than the related art. However, the method disclosed in JP-A 2004-191354 has a problem that the two mirrors must be placed accurately so as to face exactly to each other.

As described above, many of the methods of calibration in the related arts have been suffered from a problem that a wide space is required and, when mounting a camera system on an automotive vehicle, complicated works such as mounting a camera in a manufacturing line in a factory and then moving to outdoor and shooting images for calibration are necessary.

In addition, in the method disclosed in JP-A2004-191354, the orientations of the two mirrors must be aligned accurately, and the conditions are very severe and are impractical.

### BRIEF SUMMARY OF THE INVENTION

In view of such problems, it is an object of the invention to provide a calibration apparatus which is capable of carrying out camera calibration easily with high degree of accuracy even in a narrow space and a method thereof.

According to embodiments of the invention, there is provided a calibration apparatus including: a monitor;

a target to be shot by a camera to be calibrated;

an input unit configured to input a real time camera image shot by the camera to be calibrated so as to include a screen of the monitor and the target in a field of view;

a storage unit configured to store a monitor position, a target position and a focal distance of the camera, the monitor position indicating a three-dimensional position of the monitor in a three-dimensional reference coordination system, the monitor position indicating a three-dimensional position of the target in the three-dimensional reference coordination system;

a display control unit configured to obtain a recursive camera image including a plurality of target areas which correspond respectively to the target recursively by displaying the camera image on the screen of the monitor; and

a calculating unit configured to obtain a posture of the camera on the basis of the monitor position, the target position, the focal distance and target area positions indicating two-dimensional image positions of the respective plurality of target areas in the recursive camera image.

According to the invention, camera calibration easily with high degree of accuracy is achieved even in a narrow space.

### BRIEF DESCRIPTION OF THE DRAWINGS

FIG. 1 is an explanatory drawing of a calibration apparatus according to an embodiment of the invention;

FIG. 2 is a flowchart of a camera calibration procedure with the calibration apparatus;

FIG. 3 is an explanatory drawing showing a positional relation of a view, a rectangular target and a display area of a camera;

FIG. 4 is an explanatory drawing showing a camera image to be shot by the calibration apparatus;

FIG. 5 is an explanatory drawing showing a three-dimensional reference coordination system used in the calibration apparatus;

FIG. 6 is an explanatory drawing showing a geometric relation of the repeated pattern on a screen of a monitor and a camera image;

FIG. 7 is an explanatory drawing showing a process in a calculating unit;

FIG. 8 is a flowchart showing the calibration procedure carried out by the calibration apparatus; and

FIG. 9 is an explanatory drawing showing the camera calibration of stereo cameras.

### DETAILED DESCRIPTION OF THE INVENTION

Referring now to FIG. 1 to FIG. 9, a calibration apparatus 10 according to an embodiment of the invention will be described.

### (1) Configuration of Calibration Apparatus 10

A schematic configuration of the calibration apparatus 10 is shown in FIG. 1.

The calibration apparatus 10 includes a monitor 12 and a calculating unit 14 as shown in FIG. 1.

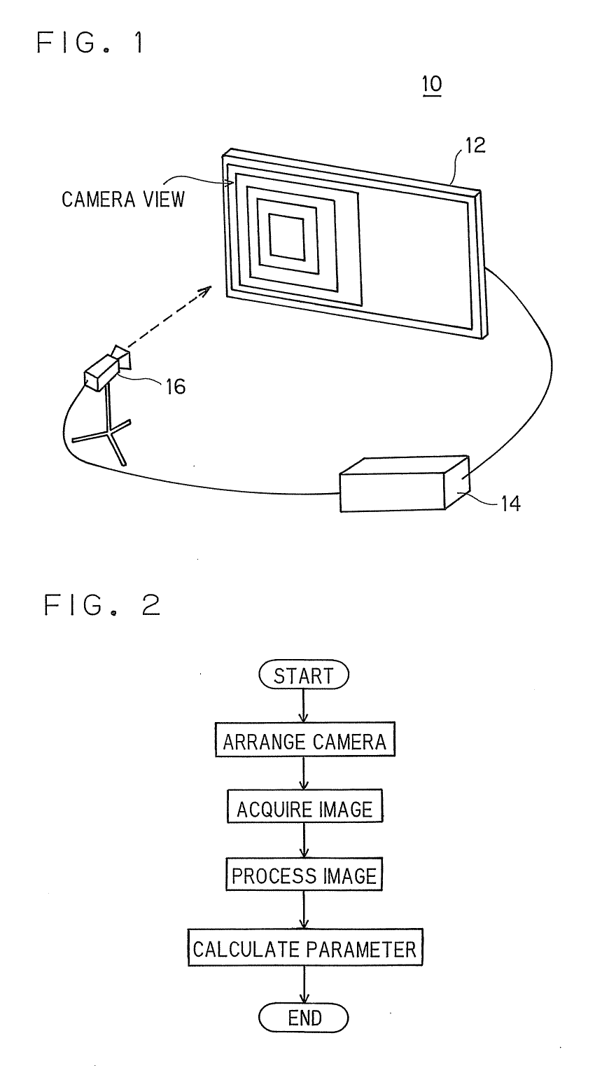

A procedure of camera calibration with the calibration apparatus 10 is shown in a flowchart in FIG. 2 and respective steps will be described below.

### (2) Installation of Camera 16

A camera 16 as a target of the camera calibration is installed in front of the monitor 12, and the camera 16 is oriented so as to exactly face a screen for displaying an image of the monitor 12. The distance between the camera 16 and the monitor 12 is adjusted in such a manner that the monitor 12 occupies most part of the view of the camera 16.

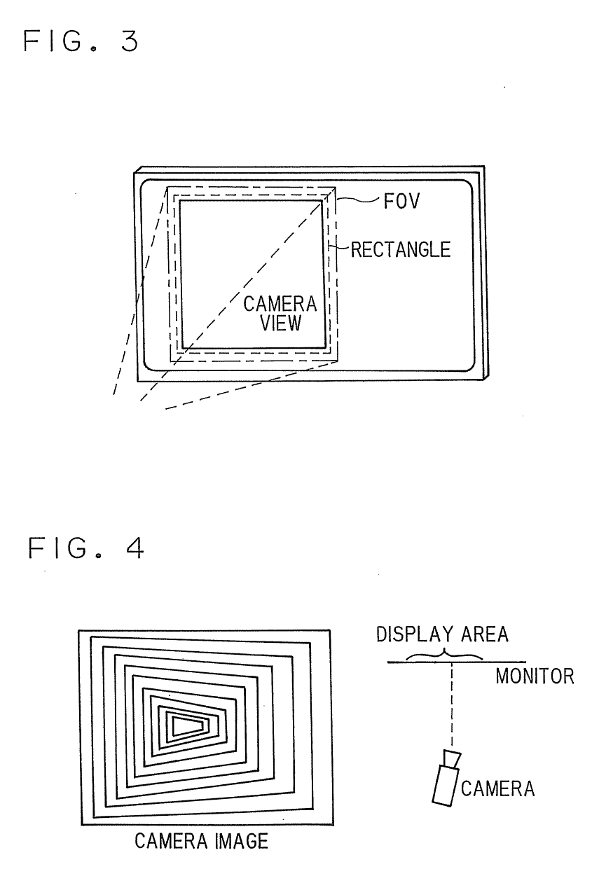

In this embodiment, it is assumed that the camera 16 is installed sufficiently near the monitor 12, and the screen of the monitor 12 occupies the entire view (FOV) of the camera 16 as shown in FIG. 3. The camera 16 is placed in such a manner that the optical axis of the camera 16 aligns with the direction of the normal line of the screen of the monitor 12 as much as possible. In other words, the camera 16 is installed in such a manner that an image pickup surface of the camera 16 and the screen of the monitor 12 extend in parallel to each other.

Calculating the position and posture of the camera 16 accurately is an object of the calibration apparatus 10, and adjustment at this time point does not have to be carried out accurately and may be done on the basis of the visual observation.

As shown in FIG. 1, the camera 16 and the monitor 12 are connected via the calculating unit 14, and camera images shot by the camera 16 are displayed on the monitor 12.

Displayed outside the camera image in the screen of the monitor 12 is a mark (target) used for the camera calibration.

In this embodiment, as shown in FIG. 3, a rectangle (a square whose inner angles at four corners are all 90°) is shown outside the camera image (camera view). This rectangle is referred to as “basic square” hereinafter. Four apexes of the basic square correspond to the targets.

The positions of the four apexes of the basic square displayed on the screen of the monitor 12 with respect to the three-dimensional reference coordination system are assumed to be known. The three-dimensional reference coordination system will be described later.

Respective sides of the basic square may be colored with a certain suitable color or added with a certain background color to sharpen the contrast as needed, so that image processing, described later, will be simplified.

### (3) Acquirement of Camera Image

After having arranged the camera 16 as descried above, camera image displayed on the screen of the monitor 12 is shot by the camera 16 by itself. An example of the camera image to be shot is shown in FIG. 4.

In a state in which the camera 16 and the monitor 12 are face to each other, an infinite loop of (a) shooting the screen of the monitor 12 with the camera 16, (b) displaying the shot camera image on the screen of the monitor 12, (c) shooting the screen of the monitor 12 with the camera 16, (d) displaying the shot camera image on the screen of the monitor 12 . . . occurs. Therefore, a pattern of repeated rectangles as shown in FIG. 4 is shot. Hereinafter, the repeated pattern is referred to as “recursive structure” in this specification.

When the image-pickup surface of the camera 16 and the screen of the monitor 12 are exactly parallel to each other, basic squares similar to each other are observed. However, the position and posture of the camera 16 are adjusted on the basis of the visual observation, and manually arranging these two planes exactly parallel to each other is actually impossible. Therefore, distortion is resulted on the basic squares on the image pickup surface of the camera 16. Such distortion is increased from the outside toward the inside. The repeated pattern varies with the position and posture of the camera 16.

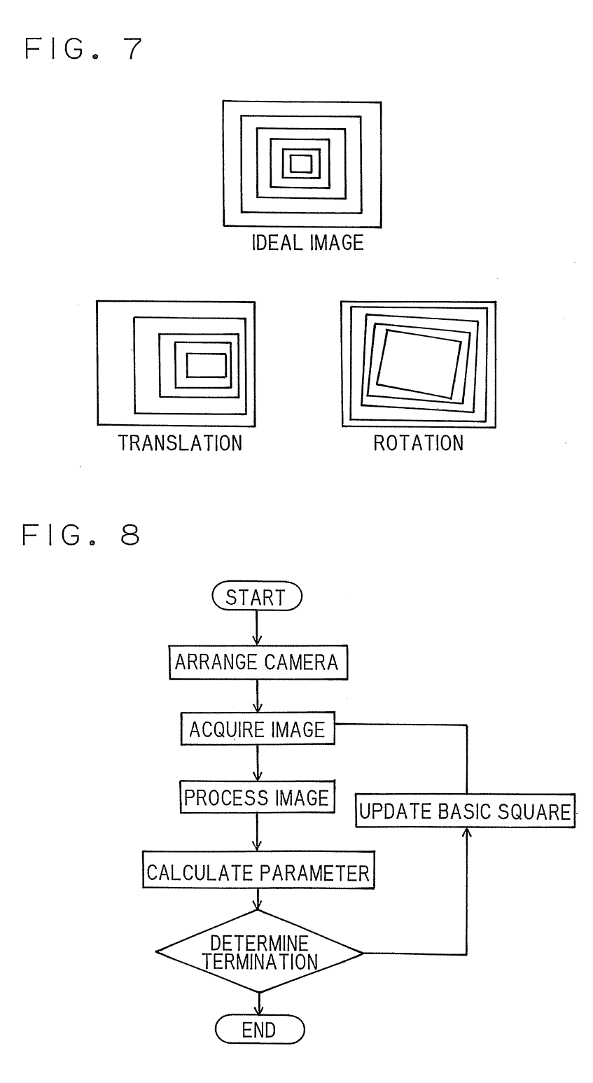

Three examples of other repeated patterns are shown in FIG. 7.

As shown by a drawing at the center in FIG. 7, a first example is an image observed in an ideal case in which the image pickup surface of the camera 16 and the screen of the monitor 12 are exactly parallel to each other, the horizontal and vertical directions of these two are completely aligned, and the center of the screen of the monitor 12 and an end of a perpendicular line extending from the center of the camera 16 to the screen of the monitor 12 match.

As shown by a drawing on the lower right side in FIG. 7, a second example is an image which is observed in a case in which the position of the camera 16 is deviated from the center of the screen of the monitor 12, and the position of the camera 16 is deviated from the center of the screen of the monitor 12.

As shown by a drawing on the lower left side in FIG. 7, a third example is a pattern which occurs by the rotation of the camera 16 about the optical axis.

In this manner, it is a characteristic of this embodiment that the position and posture of the camera 16 are obtained using the shape of the repeated pattern using the fact that different repeated patterns occur depending on the position or posture of the camera 16 with respect to the monitor 12.

In this embodiment, it is assumed that the internal parameters such as the focal distance f of a lens of the camera 16 are known, and the camera parameters obtained through the camera calibration are external parameters, that is, the three-dimensional position of the camera 16 with respect to the three-dimensional reference coordination system and the posture defined by three unit vectors.

### (4) Image Processing

As shown in FIG. 4, a plurality of squares are extracted by processing the input image which indicates the recursive structure of the basic squares.

The squares having such the recursive structure shown in the screen of the monitor 12 reduce in size as it goes from the outside to the inside, and hence extraction by the image processing becomes difficult. Therefore, K pieces of squares having a certain size are extracted from the outside. The respective squares are extracted by detecting edges from the input image and then applying straight lines for each side.

The method of extracting the K pieces of squares is optional. However, high efficiency is expected by the process in the following sequence.

First of all, the screen of the monitor 12 is shot by the camera 16 in a state in which the camera image is not displayed on the screen of the monitor. The square which exists on the shot image at this moment is only the basic square displayed on the screen of the monitor 12, and hence extraction thereof is easy. As descried later in detail, transformation of the screen of the monitor 12 into the image shot by the camera 16 is expressed by two-dimensional projective transformation, and is determined uniquely from the correspondence among four points. Therefore, the two-dimensional projective transformation is obtained using the squares extracted in the previous step in advance.

Then, when the screen of the monitor 12 is shot by the camera 16 in a state in which the camera image is displayed on the screen of the monitor, the recursive structure of the basic squares described above is observed. An outermost square is already extracted, and hence squares from the second square onward are to be extracted. Transformation between the adjacent two squares is all the same, and is composed of projective transformation from the screen of the monitor 12 to the image shot by the camera 16 described above and scale transformation from the shot image to the screen of the monitor 12. Since the projective transformation is already obtained in the previous step, the squares may be extracted considering the scale transformation only.

### (5) Calculation of Parameters

Parameters of the position and posture of the camera 16 are calculated by the basic squares displayed on the screen of the monitor 12 and projected images of the basic squares on the image (K pieces of squares extracted by the image processing).

### (5-1) Definition

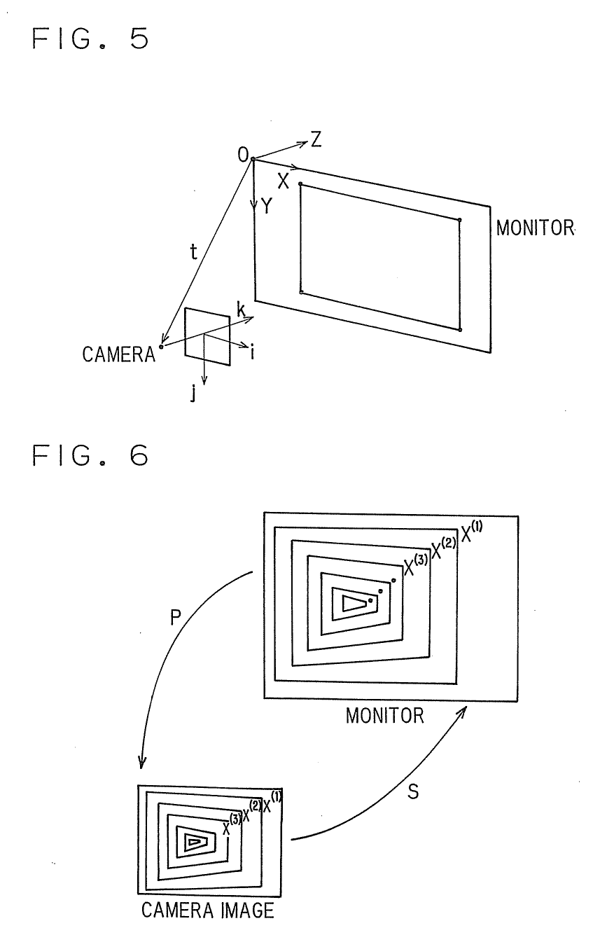

Definition of the three-dimensional reference coordination system is shown in FIG. 5. A method of setting the three-dimensional reference coordination system is optional. However, in this embodiment, the original point of the three-dimensional reference coordination system is determined to be the upper left end of the monitor 12, and the screen of the monitor 12 is referred to as a XY-plane, and the direction of the normal line of the screen of the monitor 12 is referred to as a Z-axis.

In this three-dimensional reference coordination system, the three-dimensional positions of the respective four apexes of the basic square X⁽¹⁾ are known as described above.

The position of the camera 16 is assumed to be t=(t_{X}, t_{Y}, t_{Z})^{T}, where T is a transposition sign.

The posture of the camera 16 is assumed to be a normal orthogonal basis i, j, k.

A matrix M=(i^{T}, j^{T}, k^{T})^{T} composed of these three vectors is defined. The matrix M represents the posture of the camera 16, and hence is referred to as “posture matrix”.

It is then a camera parameter obtained by the position t of the camera 16 and the posture matrix M.

(5-2) Relation between Three-Dimensional Position and Two-Dimensional Position on Image

The projected point x=(x, y)^{T} of a point X=(X, Y, Z)^{T} in a three-dimensional space onto an image is given by the formulas (1) and (2). In order to simplify calculation, the known focal distance of the lens is assumed to be f=1.

$$\begin{matrix}x = \frac{{i}^{T} ( X - t )}{{k}^{T} ( X - t )} = \frac{{r}_{11} X + {r}_{12} Y + {r}_{13} Z - {i}^{T} t}{{r}_{31} X + {r}_{32} Y + {r}_{33} Z - {k}^{T} t} & ( 1 ) \\ y = \frac{{j}^{T} ( X - t )}{{k}^{T} ( X - t )} = \frac{{r}_{21} X + {r}_{22} Y + {r}_{23} Z - {j}^{T} t}{{r}_{31} X + {r}_{32} Y + {r}_{33} Z - {k}^{T} t} & ( 2 )\end{matrix}$$

Since the plane on the monitor 12 corresponds to the XY-plane, Z=0 is satisfied. In other words, the projected point (x, y)^{T} of a point (X, Y, 0)^{T} on the monitor 12 is given by the formula (3).

$$x = \frac{{r}_{11} X + {r}_{12} Y - {i}^{T} t}{{r}_{31} X + {r}_{32} Y - {k}^{T} t} , y = \frac{{r}_{21} X + {r}_{22} Y - {j}^{T} t}{{r}_{31} X + {r}_{32} Y - {k}^{T} t} \qquad ( 3 )$$

Hereinafter, the homogeneous coordinate expression is employed for simplifying the expression. In other words, a point (X, Y) on the monitor 12, a point (x, y) on the image are expressed respectively by X=(X, Y, 1)^{T}, x=(x, y, 1)^{T}. Then, the formula (3) will be expressed as;

x=PX (4)

In this case,

$$\begin{matrix}P = MT = [ \begin{matrix}{r}_{11} & {r}_{12} & {t}_{1} \\ {r}_{21} & {r}_{22} & {t}_{2} \\ {r}_{31} & {r}_{32} & {t}_{3}\end{matrix} ] & ( 5 ) \\ T = [ \begin{matrix}1 & 0 & - {t}_{X} \\ 0 & 1 & - {t}_{Y} \\ 0 & 0 & - {t}_{Z}\end{matrix} ] & ( 6 ) \\ \{ \begin{matrix}{t}_{1} = - {i}^{T} t = - ( {r}_{11} {t}_{X} + {r}_{12} {t}_{Y} + {r}_{13} {t}_{Z} ) \\ {t}_{2} = - {j}^{T} t = - ( {r}_{21} {t}_{X} + {r}_{22} {t}_{Y} + {r}_{23} {t}_{Z} ) \\ {t}_{3} = - {k}^{T} t = - ( {r}_{31} {t}_{X} + {r}_{32} {t}_{Y} + {r}_{33} {t}_{Z} )\end{matrix} & ( 7 )\end{matrix}$$

is satisfied. The point X=(X, Y, 1)^{T} on the monitor 12 is subjected to the two-dimensional projective transformation shown by the formula (4), and is projected on the point of the image x=(x, y, 1)^{T}.
(5-3) Relation between Square on Image Pickup Surface of Camera and Square on Screen of Monitor 12

As shown in FIG. 6, the point of the outermost square on the image pickup surface of the camera is designated by x⁽¹⁾, and the points of the second, third squares are designated by x⁽²⁾, x⁽³⁾, and the point of the k^{th} square from the outside is designated by x^{(k)}. The image pickup surface of the camera, that is, the positions of x⁽¹⁾, x⁽²⁾, x⁽³⁾, . . . , x^{(k)} in the camera image are detected by through the image processing as described above.

On the other hand, the squares on the screen of the monitor 12 are also expressed as X⁽¹⁾, X⁽²⁾, X⁽³⁾ from the outside. The square X⁽¹⁾ is a basic square displayed on the outermost side of the camera image on the monitor 12, and the squares X⁽²⁾, X⁽³⁾, . . . are squares displayed in the camera image on the monitor 12. As described above, the three-dimensional positions of the respective four apexes of the basic square X⁽¹⁾ are known.

On the screen of the monitor 12, the projection of the k^{th} square X^{(k)} from the outside on the camera image is x^{(k)}. Therefore, from the formula (4),

x^{(k)}=PX^{(k)} (8)

is satisfied.

The second square X⁽²⁾ from the outside on the screen of the monitor 12 is the point x⁽¹⁾ of the outermost square on the image pickup surface of the camera displayed on the monitor 12 in an enlarged scale.

When generalized, the k^{th} square X^{(k)} from the outside on the screen of the monitor 12 is a (k−1)^{th} square from the outside x^{(k-1)} projected on the image pickup surface of the camera 16, and hence,

X^{(k)}−Sx^{(k-1)} (9)

is satisfied, where S is a matrix indicating enlargement, and is expressed with a coefficient s by;

$$S = [ \begin{matrix}s & 0 & {c}_{X} \\ 0 & s & {c}_{Y} \\ 0 & 0 & 1\end{matrix} ] \qquad ( 10 )$$

where, (cx, cy, 1)^{T} is a point of the center of the image projected on the monitor image. From the formula (8) and the formula (9), the formula (11) is obtained.

$$\begin{matrix}{x}^{( k )} = PS {x}^{( k - 1 )} = {P}^{′} {x}^{( k - 1 )} & ( 11 ) \\ {P}^{′} = PS = [ \begin{matrix}{sr}_{11} & {sr}_{12} & {t}_{1} \\ {sr}_{21} & {sr}_{22} & {t}_{2} \\ {sr}_{31} & {sr}_{32} & {t}_{3}\end{matrix} ] & ( 12 )\end{matrix}$$

is satisfied. P′ and P both indicate the two-dimensional projective transformation.

### (5-3) Calculation of Posture Matrix M of Camera 16

The posture matrix M of the camera 16 is obtained from the formula (11) shown above and the K squares x^{(k)} (where k=1, 2, . . . , K) extracted through the image processing shown above.

The four apexes of the k^{th} square are designated by x₁^{(k)}, x₂^{(k)}, x₃^{(k)}, x₄^{(k)}. The two-dimensional image positions of the x₁^{(k)}, x₂^{(k)}, x₃^{(k)}, x₄^{(k)} in the camera image are detected through the image processing in advance as described above.

From correspondence of the respective apexes of the k^{th} square and the (k−1)^{th} square which is adjacently inside the k^{th} square and the formula (11),

xᵢ^{(k)}=P′xᵢ^{(k-1)} (i=1 to 4) (13)

is obtained. The two equations are obtained from the correspondence of the respective apexes and, since there are four pairs of apexes, eight equations are obtained from a pair of the squares.

Furthermore, since there are (K−1) combinations of adjacent squares, which are adjacent to each other in the K squares, 8×(K−1) equations in total are obtained.

The projective transformation P′ is obtained by applying these equations simultaneously, where, P′ is the projective transformation, and elements thereof have indefiniteness of constant times. In other words, assuming that w=t₃′, for example, values of h₁₁ to h₃₂ are uniquely obtained with;

$${P}^{′} = w [ \begin{matrix}{sr}_{11} / w & {sr}_{12} / w & {t}_{1} / w \\ {sr}_{21} / w & {sr}_{22} / w & {t}_{2} / w \\ {sr}_{31} / w & {sr}_{32} / w & 1\end{matrix} ] = w [ \begin{matrix}{h}_{11} & {h}_{12} & {h}_{13} \\ {h}_{21} & {h}_{22} & {h}_{23} \\ {h}_{31} & {h}_{32} & 1\end{matrix} ] \qquad ( 14 )$$

Since first rows (r₁₁, r₂₁, r₃₁) of the posture matrix M are unit vectors,

from

$$\begin{matrix}{h}_{11}^{2} + {h}_{21}^{2} + {h}_{31}^{2} = {( \frac{s}{ω} {r}_{11} )}^{2} + {( \frac{s}{w} {r}_{21} )}^{2} + ( \frac{s}{w} {r}_{31} ) \\ = {( \frac{s}{w} )}^{2} ( {r}_{11}^{2} + {r}_{21}^{2} + {r}_{31}^{2} ) \\ = {( \frac{s}{w} )}^{2}\end{matrix} \qquad ( 15 )$$

and hence the following formula is obtained.

$$w / s = \pm \frac{1}{\sqrt{{h}_{11}^{2} + {h}_{21}^{2} + {h}_{31}^{2}}} \qquad ( 16 )$$

and formulas (15), (16) and a formula (14), the elements of the first row and the second row of the posture matrix M are obtained assuming;

(r₁₁, r₂₁, r₃₁)=w′(h₁₁, h₂₁, h₃₁),

(r₁₂, r₂₂, r₃₂)=w′(h₁₂, h₂₂, h₃₂) (17)

where w′=w/s.

A third row (r₁₃, r₂₃, r₃₃) of the posture matrix M is obtained from the relational formula;

(r₁₃, r₂₃, r₃₃)=(r₁₁, r₂₁, r₃₁)×(r₁₂, r₂₂, r₃₂) (18).

The sign “×” of the formula (18) represents an outer product of vector.

From the procedure shown above, the two-dimensional image position of x⁽¹⁾, x⁽²⁾, x⁽³⁾, . . . x^{(K)} in the camera image are detected through the image processing, and all the respective elements of the posture matrix M are obtained on the basis of the focal distance f and the three-dimensional positions of the respective four apexes of the basic square X⁽¹⁾.

Although the two posture matrixes M are calculated by the sign “w′”, the preferred one on the basis of the physical point of view is to be selected. For example, i=(r₁₁, r₁₂, r₁₃) which indicates the lateral direction of the image pickup surface of the camera 16 substantially matches the X-axis direction, and hence the sign of the w′ can be uniquely determined.

### (5-4) Calculation of Position of Camera 16

The position of the camera 16 t=(t_{X}, t_{Y}, t_{Z}) is calculated using the formula (4). When the apex Xᵢ⁽¹⁾ of the basic square on the monitor 12 and the projected point xᵢ⁽¹⁾ thereof are substituted into the formula (4),

xᵢ⁽¹⁾=PXᵢ⁽¹⁾ (19)

where the formula (19) represents two equations. When the four apexes are used, eight equations are obtained. Since the posture matrix M of the camera 16 is already obtained, this is also used to solve the eight equations for t=(t_{X}, t_{Y}, t_{Z})^{T}, and obtain the position of the camera 16.

With the procedure shown above, the camera calibration as the object of the embodiment, that is, calculation of the position and posture of the camera 16 with respect to the monitor 12 are enabled.

### (6) Valuation Method

It is also possible to valuate the adequacy of the calculated camera parameter according to the method shown above.

First of all, the display area is moved together with the basic square X⁽¹⁾ so that the center of the display area on the screen of the monitor 12 matches the end of the perpendicular line extending from the calculated position t of the camera 16 to the plane of the monitor 12, and the X⁽¹⁾ is transformed as follows.

X′=P⁻¹TX (20)

In order to simplify the expression, the upper case “(1)” is omitted. The projection of X′ onto the image is given by the formula (21).

x′=PX′=P(P⁻¹TX)=TX (21)

On the other hand, the posture matrix M of the ideal camera 16 (hereinafter, referred to as “ideal camera 16”) in which three posture vectors match X, Y, Z-axes of the three-dimensional reference coordination system is as expressed by the expression (22).

M=I (I: unit matrix) (22)

From Expression 15 and the formula (4), the projected point x″ obtained by shooting the basic square with the ideal camera 16 is as shown by the formula (23).

x″=TX (23)

From the formula (21) and the formula (23), the value x′ matches the value x″. In other words, when the basic square is transformed by the formula (20), the projected figure of the square after transformation is the same as the projected image in the case in which the basic square is shot by the ideal camera 16, and the repeated pattern is as shown at the upper center in FIG. 7. In other words, from the similarity of the observed repeated pattern or the invariant property of the directions of the respective sides, the adequacy of the calculated camera parameter is valuated.

### (7) Recalculating Method

It is also possible to improve the accuracy by repeating recalculation until the ideal repeated pattern as such is observed. FIG. 8 shows a procedure of the calibration in the case in which the recalculation is included.

After having calculated the parameters, termination determination is carried out on the basis of the magnitude of the update from the calculation of the previous time. When it is determined that the recalculation is necessary, the shape of the basic square is deformed by the formula (20), and the calculation is carried out using the deformed square.

With this procedure, the repeated pattern approaches an ideal shape, and hence the respective sides of the square become horizontal lines or perpendicular lines. Therefore, extraction of the straight line by the image processing is simplified, and the accuracy of extraction is improved.

### (8) Modification 1

The calibration apparatus 10 is capable of calibrating a plurality of the cameras 16.

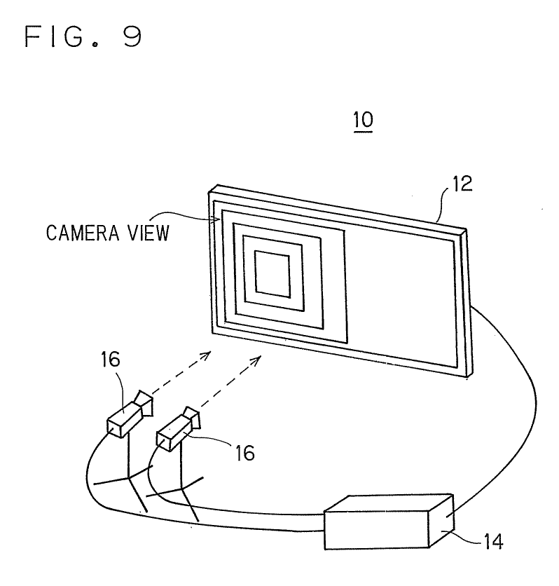

FIG. 9 shows an appearance of calibration of the stereo cameras 16. The calibration is performed independently for the respective cameras 16.

When carrying out the calibration of the left camera 16, the left image is displayed on the monitor 12. When carrying out the calibration of the right camera 16, the right image is displayed. The procedure of the process to be performed for the respective cameras 16 is the same as the case in which the single camera 16 is employed.

### (9) Modification 2

In this embodiment, the screen is set in the interior of the monitor 12, and the square drawn outside the screen is used as the target of the calibration. However, it is also possible to display the image over the entire monitor 12, and use the outer frame of the monitor 12 as the target.

### (10) Modification 3

In the embodiment shown above, the respective apexes of the basic square are used as the targets. However, the targets may be any targets as long as there are three or more points, and hence the invention is not limited to the square, and a triangle and a polygon are also applicable.

### (11) Modification 4

In this embodiment the method of calculating the position and posture of the camera 16 automatically has been described. However, the posture of the camera 16 with respect to the monitor 12 may be adjusted manually using the infinite repeated pattern as such generated by the camera 16 and the monitor 12.

For example, when alignment of the orientations of the plurality of cameras 16 is desired, it is necessary to use a substance located at a long distance as the target, and hence a wide space is required. However, by adjusting the orientations while observing the repeated pattern, the orientations are aligned relatively accurately even in a narrow space.

Alternatively, it is also possible to adjust the position of the camera 16 by a camera moving apparatus or manually on the basis of the posture of the camera 16 calculated in the procedure shown above.

### (12) Other Modifications

The invention is not limited to the embodiments shown above as is, and components may be modified without departing the scope of the invention before embodying in the stage of implementation.

It is also possible to achieve the invention in various modes by combining the plurality of the components disclosed in the embodiments shown above as needed. For example, some components may be eliminated from all the components shown in the embodiments.

Furthermore, the components from the different embodiments may be combined as needed as well.

Other modifications are possible without departing the scope of the invention.

### (13) Applications

As an application of the calibration apparatus 10, for example, it may be applied when two cameras of stereo view are mounted on a vehicle.

More specifically, the camera calibration is obtained by arranging the monitor 12 in front of the vehicle while satisfying the conditions described above.

What is claimed is:

1. A calibration apparatus comprising:
a monitor;
a target to be shot by a camera to be calibrated;
an input unit configured to input a real time camera image shot by the camera to be calibrated so as to include a screen of the monitor and the target in a field of view;
a storage unit configured to store a monitor position, a target position and a focal distance of the camera, the monitor position indicating a three-dimensional position of the monitor in a three-dimensional reference coordination system, the monitor position indicating a three-dimensional position of the target in the three-dimensional reference coordination system;
a display control unit configured to obtain a recursive camera image including a plurality of target areas which correspond respectively to the target recursively by displaying the camera image on the screen of the monitor; and
a calculating unit configured to obtain a posture of the camera on the basis of the monitor position, the target position, the focal distance and target area positions indicating two-dimensional image positions of the respective plurality of target areas in the recursive camera image.

2. The apparatus according to claim 1, wherein the calculating unit includes:
a detection unit configured to detect the target area positions of the target areas from the outermost target area to the K^{th} target area in the recursive camera image; and
a projective matrix calculating unit configured to obtain a projective matrix from the k^{th} (where k=1, 2, . . . K−1) target area position to the (k+1)^{th} target area position on the basis of the k^{th} target area position and the (k+1)^{th} target area position; and
a posture matrix calculating unit configured to obtain a posture matrix on the basis of the monitor position, the target position and the projective matrix, the posture matrix indicating a camera posture of the camera.

3. The apparatus according to claim 1, wherein the calculating unit further obtains a camera position from the camera posture and the target position, the camera position indicating the three-dimensional position of the camera.

4. The apparatus according to claim 1, wherein the target includes respective apexes of a square displayed on the screen of the monitor.

5. The apparatus according to claim 3, comprising a readjusting unit configured to readjust current posture of the camera and current position of the camera on the basis of the camera posture and the camera position.

6. A calibration method comprising:
a step of inputting a real time camera image shot by a camera to be calibrated so as to include a screen of the monitor and the target shot by the camera to be calibrated in a field of view;
a step of storing a monitor position, a target position and a focal distance of the camera, the monitor position indicating a three-dimensional position of the monitor in a three-dimensional reference coordination system, the monitor position indicating a three-dimensional position of the target in the three-dimensional reference coordination system;
a step of controlling display for obtaining a recursive camera image including a plurality of target areas which correspond respectively to the target recursively by displaying the camera image on the screen of the monitor; and
a step of calculating for obtaining a posture of the camera on the basis of the monitor position, the target position, the focal distance and target area positions indicating two-dimensional image positions of the respective plurality of target areas in the recursive camera image.

7. The method according to claim 6, wherein the step of calculating includes:
a detection unit configured to detect the target area positions of the target areas from the outermost target area to the K^{th} target area in the recursive camera image; and
a projective matrix calculating unit configured to obtain a projective matrix from the k^{th} (where k=1, 2, . . . K−1) target area position to the (k+1)^{th} target area position on the basis of the k^{th} target area position and the (k+1)^{th} target area position; and
a posture matrix calculating unit configured to obtain a posture matrix on the basis of the monitor position, the target position and the projective matrix, the posture matrix indicating a camera posture of the camera.

8. The method according to claim 6, wherein the calculating step further obtains a camera position from the camera posture and the target position, the camera position indicating the three-dimensional position of the camera.

9. The method according to claim 6, wherein the target includes respective apexes of a square displayed on the screen of the monitor.

10. The method according to claim 8, comprising a step of readjusting current posture of the camera and current position of the camera on the basis of the camera posture and the camera position.
